(19) United States
(12) Patent Application Publication
(10) Pub. No.: US 2009/0254364 A1
(43) Pub. Date: Oct. 8, 2009

(54) MediCAD Chinese medical system

(76) Inventors: Yi-Yun Chen, Shanghai (CN); Ming-Yan Dong, Shanghai (CN); Da-Qian Chen, Shanghai (CN); Zhang-zhong Zhao, Shanghai (CN)

Correspondence Address: DAVID AND RAYMOND PATENT FIRM, 108 N. YNEZ AVE., SUITE 128, MONTEREY PARK, CA, 91754, US

(21) Appl. No.: 12/384,106

(22) Filed: Mar. 30, 2009

Related U.S. Application Data
(63) Continuation-in-part of application No. 10/336,391, filed on Jan. 6, 2003, now abandoned.

(51) Int. Cl. G06Q 50/00; G06F 17/28

(52) U.S. Cl. 705/2; 704/2

(57) ABSTRACT

A Chinese medical system includes a signal input device for entering information, an input signal generated in response to the signal input device, a database system comprising a diagnostic database storing a diagnostic information of Chinese diagnostic information and a matching analyzer analyzing the input signal and matching the input signal with the diagnostic information, a diagnostic output signal generated in response to the matching analyzer of the database system, a responsive system including an action database storing a treatment methods information, a retriever retrieving the treatment methods information in response to the diagnostic output signal to generate a retriever signal, a signal transmitter receiving the diagnostic output signal and transmitting the diagnostic output signal to the retriever, and a responsive signal generator generating a responsive signal from gathering and organizing the retriever signal.

### CROSS REFERENCE OF RELATED APPLICATION

This is a Continuation-In-Part application of a non-provisional application having an application Ser. No. of 10/336,391 and a filing date of Jan. 6, 2003.

### BACKGROUND OF THE PRESENT INVENTION

1. Field of Invention

The present invention relates to a medical system, and more particularly to a MediCAD Chinese Medical System that provides an information database for assisting diagnosis.

2. Description of Related Arts

Traditional Chinese medicine is broadly used in the Chinese society and increasingly accepted as alternative therapies in foreign countries. Traditional Chinese medicine is highly emphasized on the past experience of our ancestors and the medical theory, and the medical hypothesis or the medical application information are collectively recorded in many different books, journals, dictionaries or encyclopedia. However, there is no one existing organized or standardized informative database for the Traditional Chinese medicine. It is very difficult to have a complete collection of Chinese medicine information for study, research, or application purposes. Therefore, the research and development and the applications of the traditional Chinese medicine are limited.

Applications of Chinese medicine include medical diagnosis and medical treatment by practitioners. The accuracy of medical diagnosis is highly depended on the practitioner's experience and available information. Since there is no one existing organized and standardized informative database for medical diagnosis of Chinese medicine, the accuracy of medical diagnosis is adversely affected. If there is a way to retrieve information during medical diagnosis, the accuracy of diagnosis will be greatly increased and the effectiveness and efficiency of diagnosis will be enhanced.

The basis of Chinese medicine is to restore the body balance of human body. It can be the balance of gold, wood, water, fire, and earth. And there is usually not one and only one method of restoring the balance of our bodies. Different ways of treatment may come up to the same result and the most appropriate and suitable method of treatment depends on the experience of the practitioners. Therefore, if there is a system that can provide different methods of treatments according to a corresponding diagnosis result, the selection of treatment method of practitioners will be made more easily and effectively. Furthermore, the relatively inexperience practitioners will build up their knowledge and professionalism through the Chinese medical system and the development of the Chinese medicine may be speed up dramatically as the inexperience practitioners can have more chance of learning treatment methods of different practitioners. This kind of intra-communication will greatly benefit the development of the Traditional Chinese medicine and will ultimately benefit our human society.

Comparisons and researches have been carried out between western medicine and Chinese medicine. Due to the nonsystematic records of the Chinese medicine, it is very difficult to study the difference and the same of the two kind of medical theories. Besides, it poses great difficulty for non-Chinese people to learn or understand the Chinese medicine. Therefore, if there is a systematic informative database for the Chinese medicine, which is capable of providing a language selection, studies of the difference and the same of the western medicine and Chinese medicine will be made possible for non-Chinese people and Chinese people. Thus, studies will be more thorough and objective in different directions and our human society will ultimately have a great step towards medical studies.

### SUMMARY OF THE PRESENT INVENTION

It is an object of the present invention to provide a Chinese medical system for providing a standardized and organized information database.

It is another object of the present invention to provide a Chinese medical system for providing a standardized and organized information database for assisting diagnosis for practitioners.

It is another object of the present invention to provide a Chinese medical system, wherein the Chinese medical system provides an information database for suggesting a predetermined therapies method for a corresponding diagnosis result.

It is another object of the present invention to provide a Chinese medical system, such that practitioners are capable of retrieving information from the database effectively and efficiency.

It is another object of the present invention to provide a Chinese medical system, wherein the Chinese medical system provides an information database for researches and studies.

It is another object of the present invention to provide a Chinese medical system, wherein the Chinese medical system provides a discussion section such that practitioners can exchange information through the Chinese medical system.

Accordingly, in order to accomplish the above objects, the present invention provides a medical system comprising:

a signal input device for entering information to said medical system, wherein an input signal is generated in response to the information entered in said signal input device;

a database system communicating with said signal input device and having a diagnostic database containing Chinese diagnostic information involving Chinese medicine, wherein said database system is capable of analyzing and matching said input signal, wherein said database system is adapted to generate a diagnostic output signal after analyzing and matching said input signal from said signal input device;

a responsive system receiving said diagnostic output signal, wherein said responsive system is arranged to store treatment methods information in Chinese medicine and analyze said diagnostic output signal to formulate a treatment method in Chinese medicine which is optimal with respective to said diagnostic output signal from said treatment methods information in Chinese medicine, wherein said treatment method is delivered through a responsive signal; and

an output device connected with said responsive system for receiving said responsive signal and displaying said corresponding treatment methods information on said output device.

These and other objectives, features, and advantages of the present invention will become apparent from the following detailed description, the accompanying drawings, and the appended claims.

### BRIEF DESCRIPTION OF THE DRAWINGS

FIG. 1 is a block diagram of a Chinese medical system according to a first preferred embodiment of the present invention.

FIG. 2 is a block diagram of a Chinese medical system according to the first preferred embodiment of the present invention.

FIG. 3 is a block diagram of a Chinese medical system according to the first preferred embodiment of the present invention, wherein the Chinese medical system is link to a predetermined Host system.

FIG. 4 is a block diagram of a Chinese medical system according to the first preferred embodiment of the present invention, wherein the Chinese medical system is link to a language system.

FIG. 5 is a block diagram of a Chinese medical system according to the first preferred embodiment of the present invention, wherein the Chinese medical system comprises a visual and audio display as an output.

FIG. 6 is a block diagram of a Chinese medical system according to second preferred embodiment of the present invention.

FIG. 7 is a flow chart of a method of using a Chinese medical system for diagnosis.

FIG. 8 is a first illustrative diagram of the Chinese medical system according to the above preferred embodiment of the present invention, illustrating a first example of output screen generated by the output device.

FIG. 9 is a second illustrative diagram of the Chinese medical system according to the above preferred embodiment of the present invention, illustrating a second example of output screen generated by the output device.

FIG. 10 is a third illustrative diagram of the Chinese medical system according to the above preferred embodiment of the present invention, illustrating a third example of output screen generated by the output device.

FIG. 11 is a schematic diagram of a Chinese medical system according to the above preferred embodiment of the present invention.

FIG. 12 a fourth illustrative diagram of the Chinese medical system according to the above preferred embodiment of the present invention, illustrating a fourth example of output screen generated by the output device.

### DETAILED DESCRIPTION OF THE PREFERRED EMBODIMENT

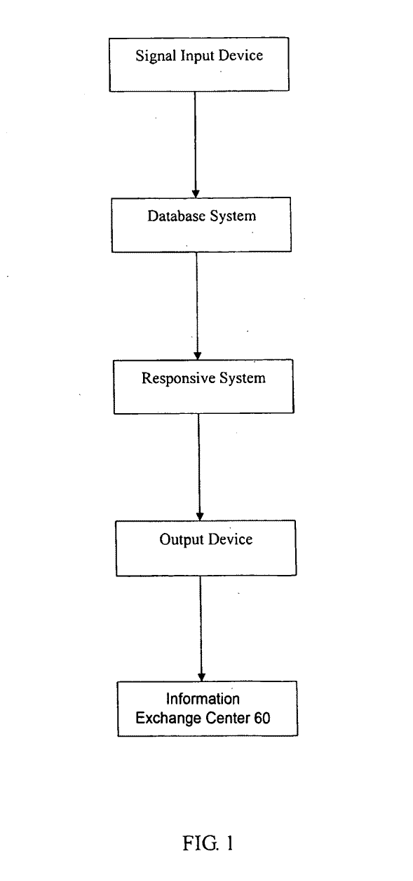

Referring to FIG. 1 of the drawings, a box diagram of a Chinese medical system according to the first preferred embodiment is illustrated. The Chinese medical system comprises a signal input device 10, a database system 20, a responsive system 30 and an output device 40.

The signal input device 10 is used for entering information. The signal input device 10 can be of any kinds, such as a keyboard, a mouse, an audio transmitter, a movement sensor, a thermo-sensor, a pulse sensor.

An input signal S1 is then generated in response to the information entered to the signal input device 10.

The database system 20 is communicated with the signal input device, wherein the database system 20 stores a Chinese diagnostic information and matches the input signal S1 with the Chinese diagnostic information. A diagnostic output signal S2 is then generated from the database system 20. The Chinese diagnostic information stored may include information of official standards of Chinese medicine, official standards of international western medicine, rules and regulations of Chinese medicine, common diagnostic methods of Chinese medicine, official encyclopedia of Chinese medicine, and official gazette of Chinese medicine.

The database system 20 may further comprise means for expanding the stored information, such as an extra memory or an extra plug-in connector adapted for receiving and storing any additional information or for updating the stored information of the database system.

The responsive system 30 communicated with the database system 20 stores a treatment methods information, which includes information from official standards of Chinese medicine, official standards of international western medicine, rules and regulations of Chinese medicine, common diagnostic methods of Chinese medicine, official encyclopedia of Chinese medicine, and official gazette of Chinese medicine.

The responsive system 30 receives the diagnostic output signal S2 from the database system 20, analyses the diagnostic output signal S2 and retrieves the treatment methods information to generate a responsive signal S4.

The responsive system 30 may further comprise a second means for expanding the responsive system, such as an extra memory or an extra plug in connector adapted for receiving and storing any additional information or for updating the treatment methods information of the responsive system 30.

The output device 40 receives the responsive signal S4 from the responsive system 30 and display the treatment methods information in response to the responsive signal S4. The output device 40 may be of any forms, such as a monitor, a printer, a memory storage like CD or floppy disk, or a speaker. Furthermore, the output device 40 may also comprise an extendable link which is capable of communicating to a second Chinese medical system or communicating to other systems, such as a host system or a hospital system to facilitate different uses.

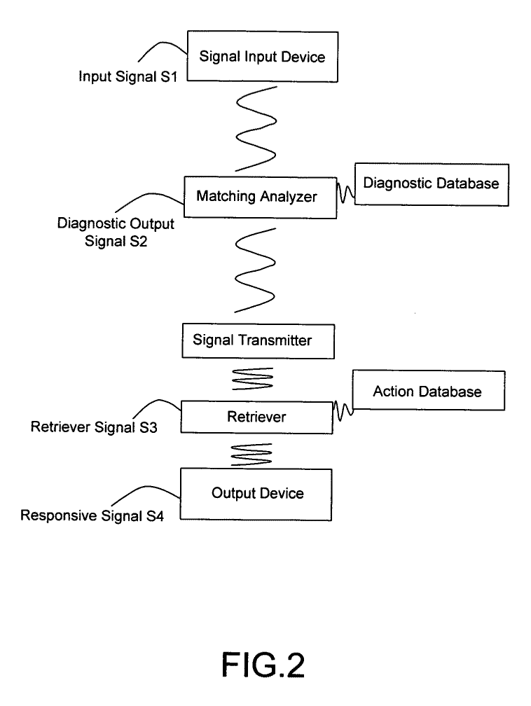

Referring to FIG. 2 of the drawings, a detailed box diagram of a Chinese medical system according to a first preferred embodiment is illustrated. The Chinese medical system comprises a signal input device 10, a database system 20, a responsive system 30 and an output device 40.

The signal input device 10 is used for entering information. The signal input device 10 can be of any kinds, such as a keyboard, a mouse, an audio transmitter, a movement sensor, a thermo-sensor, a pulse sensor.

An input signal S1 is then generated in response to the information entered to the signal input device 10.

The database system 20 communicating with the signal input device 10 comprises a diagnostic database 21 storing diagnostic information of Chinese diagnostic information (i.e. diagnostic information regarding Chinese medicine) and a matching analyzer 22 analyzing the input signal S1 and matching the input signal S1 with the diagnostic information to generate a diagnostic output signal S2. The diagnostic database 21 may include information of official standards of Chinese medicine, official standards of international western medicine, rules and regulations of Chinese medicine, common diagnostic methods of Chinese medicine, official encyclopedia of Chinese medicine, and official gazette of Chinese medicine.

According to the preferred embodiment of the present invention, the official information of Chinese medicine may include official “Classification and Codes of diseases and ZHENG of traditional Chinese medicine”, “Clinic terminology of traditional Chinese medical diagnosis and treatment—Diseases”, “Clinic terminology of traditional Chinese medical diagnosis and treatment—Syndromes”, “Clinic terminology of traditional Chinese medical diagnosis and treatment—Therapeutic methods”, and/or “Criteria of diagnosis and therapeutic effect of diseases and syndromes in traditional Chinese medicine”. These are official publications of Chinese medicine.

The database system 20 may further comprise means for expanding the database system, such as an extra memory or an extra plug-in connector adapted for receiving and storing any additional information or for updating the diagnostic information of the diagnostic database 21 of the database system 20.

The responsive system 30 comprises an action database 31, a signal transmitter 32, a retriever 33, and a responsive signal generator 34. The action database 31 stores a treatment methods information, which includes information from official standards of Chinese medicine, official standards of international western medicine rules and regulations of Chinese medicine, common diagnostic methods of Chinese medicine, official encyclopedia of Chinese medicine, and official gazette of Chinese medicine.

The signal transmitter 32 communicating with the database system 20 is adapted for receiving the diagnostic output signal S2 and then transmitting the diagnostic output signal S2 to the retriever 33.

The retriever 33 of the responsive system 30 is responsible for retrieving the treatment methods information in response to the diagnostic output signal S2 to generate a retriever signal S3.

The responsive signal generator 34 then generates a responsive signal S4 from gathering and organizing the retriever signal S3.

The responsive system 30 may further comprise a second means for expanding the database system, such as an extra memory or extra plug-in connector adapted for receiving and storing any additional information or for updating the treatment method information of the action database 31.

The output device 40 communicates with the responsive system 30, receiving the responsive signal S4 and displaying the corresponding treatment methods information of the action database 31. The output device 40 may be of any forms, such as a monitor, a printer, a memory storage like CD or floppy disk, or a speaker. Furthermore, the output device 40 may also comprise an extendable link which is capable of communicating to a second Chinese medical system or communicating to other systems, such as a host system or a hospital system to facilitate different uses.

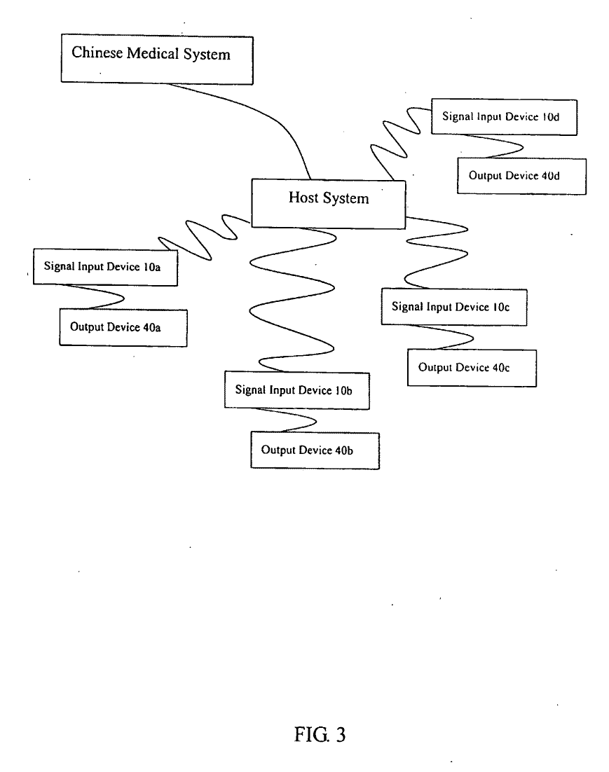

Referring to FIG. 3 of the drawings, a Chinese medical system linking to a predetermined host system is illustrated. The host system may be a central networking system or a server system.

When the Chinese medicine is linked to a central networking system, different users at different locations may communicate with each other. For example, an user A may send questions along with the diagnostic output signal S2, the retriever signal S3 and the responsive signal S4 to an user B. Then, user B can involve in having discussion with the user A and assist in coming up with the best treatment methods.

Furthermore, when the Chinese medical system is used in a building, it is possible to share the Chinese medical system for multi-users. The Chinese medical system may further comprise a signal input device system and a corresponding output device system. The signal input device system comprises signal input device 10a, 10b, 10c, 10d . . . and the output device system comprises output device 40a, 40b, 40c, 40d . . . correspondingly. Therefore, different users can use one corresponding signal input device and output device for access to the Chinese medical system. Intra-networking or inter-networking is both possible for the Chinese medical system.

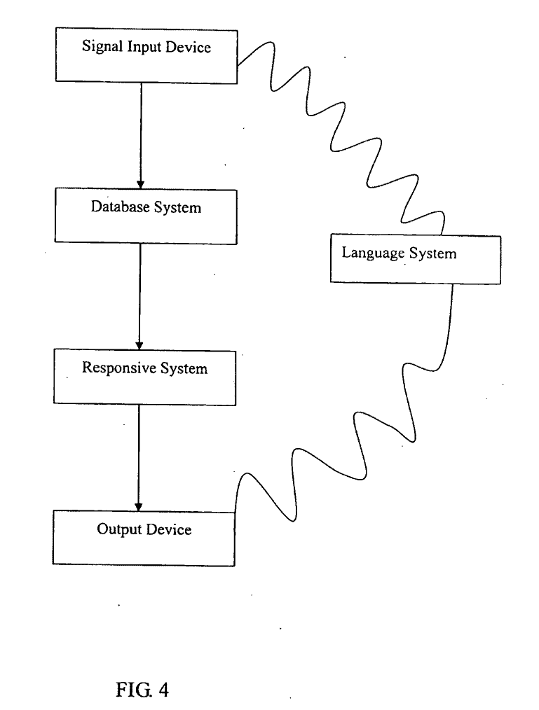

Referring to FIG. 4 of the drawings, a Chinese medical system of the present invention is illustrated, wherein the Chinese medical system is connected to a language system 50.

The language system 50 comprises at least two language databases, such as a Chinese language database D1 and an English database D2. When the information entered is in the form of English, the language system 50 transforms the information entered into a predetermined default language of the Chinese medical system, for example, Chinese in this case. Then, the Chinese medical system is capable to proceed and generates a responsive signal S4.

Then, the responsive signal S4 is sent to the language system 50 for translating the default language to English such that even an English user may use the Chinese medical system when the default language of the system is in Chinese. Different language systems maybe incorporated into the language system 50 for different language users.

Furthermore, the language system 50 further comprises a reference database such that explanation of words used is included in the system.

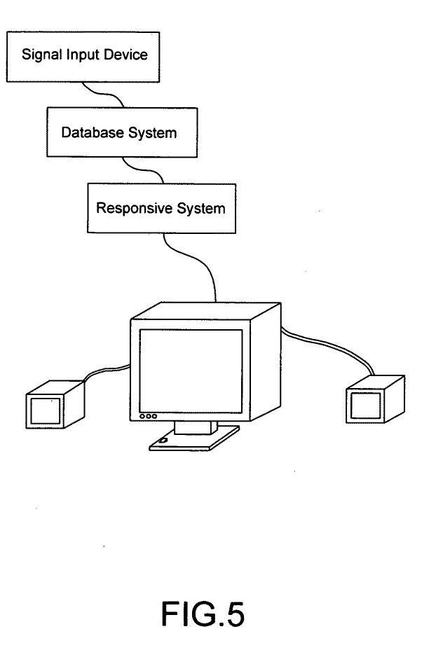

Referring to FIG. 5 of the drawings, a Chinese medical system is illustrated and the Chinese medical system is connected to a visual and audio display as an output device 40.

The visual and audio display is a screen incorporated with a speaker. Therefore, when an user can see and listen to the result. The visual and audio display may also be used to present an animation such that the treatment methods can be shown clearly and systematically with a predetermined sequenced steps.

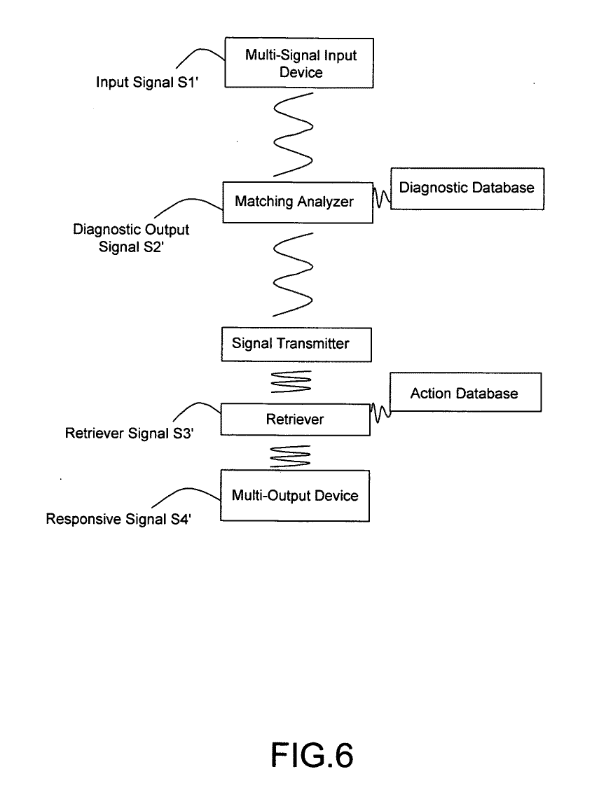

Referring to FIG. 6 of the drawings, a Chinese medical system according to a second preferred embodiment is illustrated. The Chinese medical system comprises a multi-signal input device 10′, a database system 20′, a responsive system 30′ and a multi-output device 40′.

The multi-signal input device 10′ is used for entering information. The signal input device 10 can be of any kinds, such as a keyboard, a mouse, an audio transmitter, a movement sensor, a thermo-sensor, a pulse sensor. For example, a palm-shaped sensor consisting of a thermo-sensor and a pulse sensor is illustrated in FIG. 6.

Then, an input signal S′ is generated in response to the multi-signal input device 10′.

The database system 20′ communicating with the multi-signal input device 10′ comprises a diagnostic database 21′ storing a diagnostic information of Chinese diagnostic information and a matching analyzer 22′ analyzing the input signal S1′ and matching the input signal S1′ with the diagnostic information to generate a diagnostic output signal S2′. The diagnostic database 21′ may include information of official standards of Chinese medicine, official standards of international western medicine, rules and regulations of Chinese medicine, common diagnostic methods of Chinese medicine, official encyclopedia of Chinese medicine, and official gazette of Chinese medicine.

The database system 20′ may further comprise means for expanding the database system, such as an extra memory or an extra plug-in connector adapted for receiving and storing any additional information or for updating the diagnostic information of the diagnostic database 21′ of the database system 20′.

The responsive system 30′ comprises an action database 31′, a signal transmitter 32′, a retriever 33′, and a responsive signal generator 34′. The action database 31′ stores a treatment methods information, which includes information from official standards of Chinese medicine, official standards of international western medicine, rules and regulations of Chinese medicine, common diagnostic methods of Chinese medicine, official encyclopedia of Chinese medicine, and official gazette of Chinese medicine.

The signal transmitter 32′ communicating with the database system 20′ is adapted for receiving the diagnostic output signal S2′ and then transmitting the diagnostic output signal S2′ to the retriever 33′.

The retriever 33′ of the responsive system 30′ is responsible for retrieving the treatment methods information. A retriever signal S3′ is generated in response to the diagnostic output signal S2′ and accordingly the treatment methods information is retrieved.

The responsive signal generator 34′ then generates a responsive signal S4′ from gathering and organizing the retriever signal S3′.

The responsive system 30′ may further comprise a second means for expanding the database system, such as an extra memory or an extra plug-in connector adapted for receiving and storing any additional information or for updating the treatment method information of the action database 31′.

The multi-output device 40′ communicates with the responsive system 30′, receiving the responsive signal S4 and displaying the corresponding treatment methods information of the action database 31′. The output device 40′ may be of any forms, such as a monitor, a screen, a printer, a memory storage like CD or floppy disk, or a speaker. For example, a screen and a printer are illustrated in FIG. 6.

Furthermore, the output device 40′ may also comprise an extendable link which is capable of communicating to a second Chinese medical system or communicating to other systems, such as a host system or a hospital system to facilitate different uses.

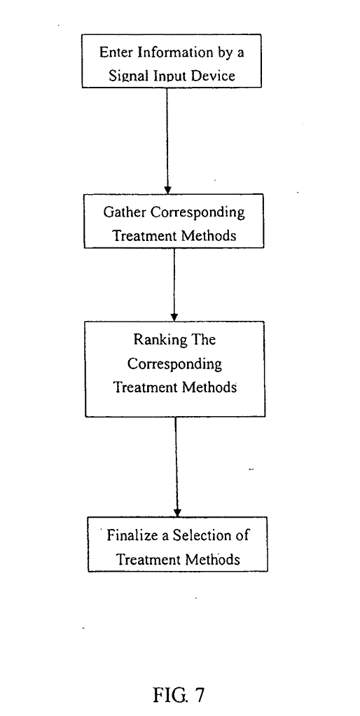

Referring to FIG. 7 of the drawings, a method of using a Chinese medical system according to the first preferred embodiment for diagnosis is illustrated. The method of using the Chinese medical system comprises the steps of:

(a) entering information by the signal input device;

(b) gathering corresponding treatment methods from the Chinese medical system;

(c) ranking the corresponding treatment methods from a set of predetermined factors; and

(d) finalizing a selection of the treatment methods.

The information entered may be in the form of typing, or direct data from an audio transmitter, a movement sensor, a thermo-sensor, a pulse sensor. The information may be body weight, body height, age, sex, body temperature, pulse rate, blood pressure, eye appearance, skin appearance, skin tension, nail color, and any other information.

The set of predetermined factors may be of any kinds, such as a previous successful rate, a time used for successful treatment, and a successful level of previous treatment.

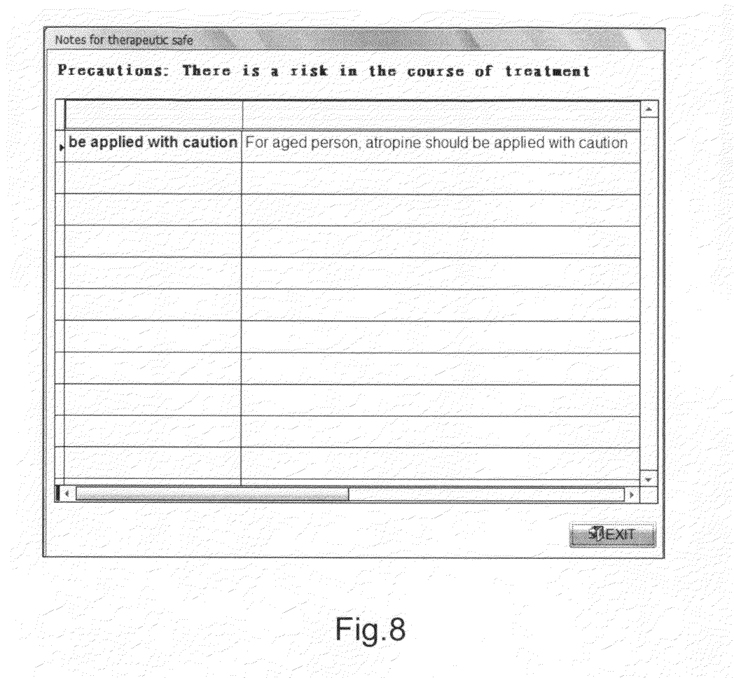

In order to further elaborate the present invention, various applications of the medical system is explained below. At the outset, the medical system is capable of taking into account various information regarding a patient's profile, as given in Table 1 below. A sample diagnostic result is shown in FIG. 8 to FIG. 10 of the drawings.

TABLE 1

| | | | | | Laboratory |
|---|---|---|---|---|---|
| | Drugs | Treatment | Operation | Examination | test |
| Age | ✓ | ✓ | ✓ | ✓ | ✓ |
| Sex | ✓ | ✓ | ✓ | ✓ | ✓ |
| Past | ✓ | ✓ | ✓ | ✓ | ✓ |
| history | | | | | |
| Present | ✓ | ✓ | ✓ | ✓ | ✓ |
| history | | | | | |
| Drug | ✓ | ✓ | ✓ | ✓ | ✓ |
| allergy | | | | | |

It is worth mentioning that each of the disease or medical conditions stored in the database system 20 may be programmed to be represented by a predetermined code, so that a system of diagnostic practice may be developed within the database system using these predetermined codes.

For example, a code “00053” may represent kidney disorder or renal insufficiency, a code “00126” represents patient treated with glucose, a code “01589” represents hemorrhagic tendency, and a code “10153” represents glucose is prohibited for patient with kidney disorder or renal insufficiency. A user of the medical system, such as a doctor in oriental medicine, may establish relationship between two or more predetermined codes. For example, the code “10153” may be represented the relationship of code “00053”+“00126”.

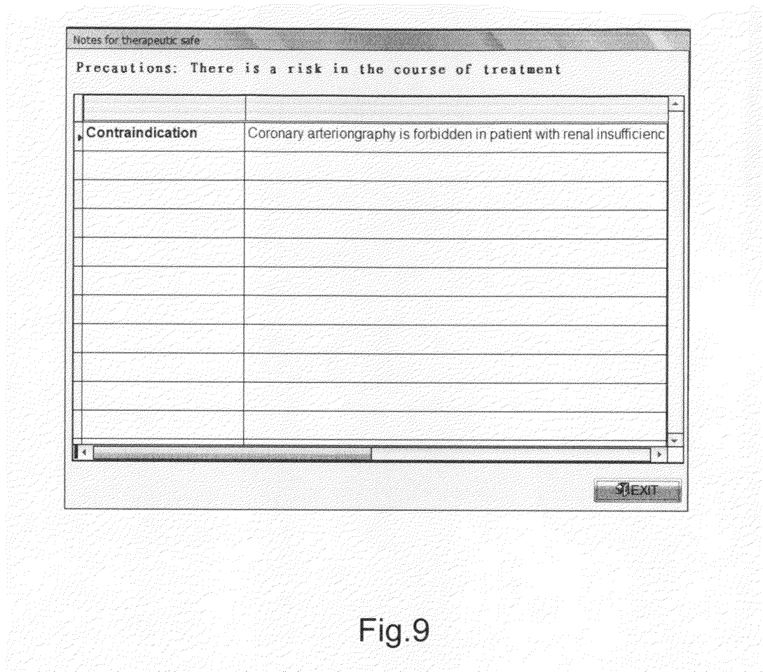

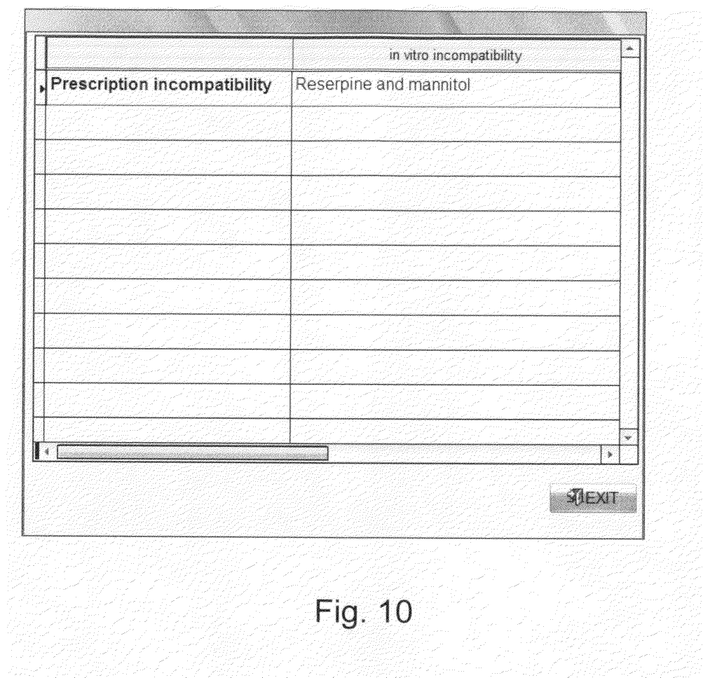

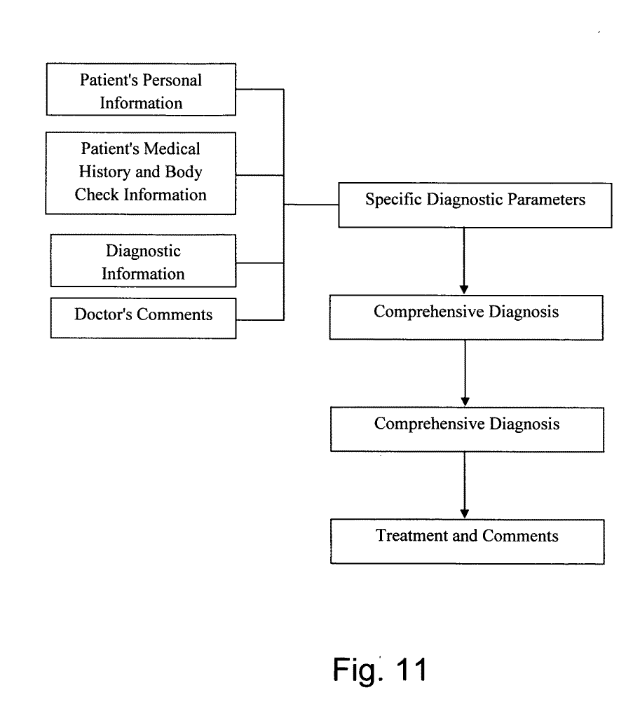

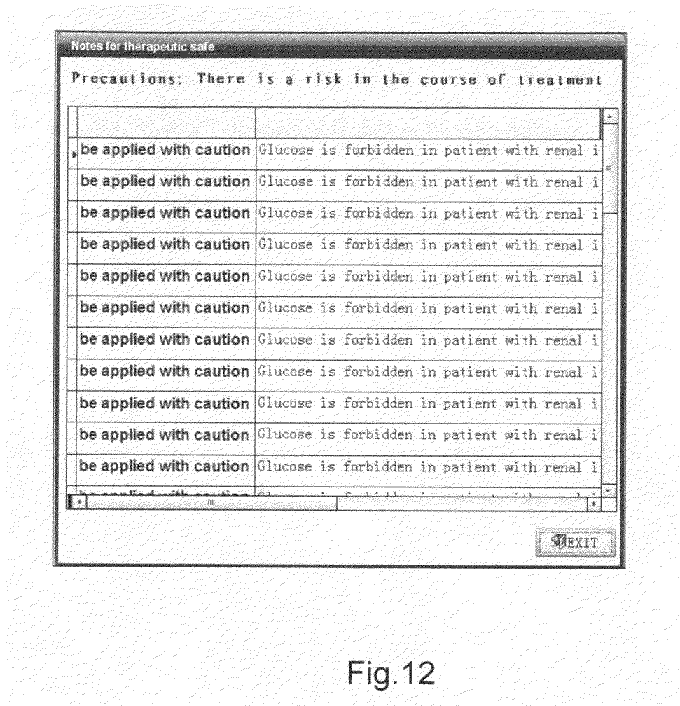

On the other hand, a wide variety of information can be inputted into through the signal input device 10. The information may include clinical information regarding a particular patient. For example, the information may include patient's personal information, body information, medical history, diagnostic information, comments of previous medical officers or personnel etc. The medical system of the present invention provides a platform for expanding upon such different kinds of information to comprehensively deal with different situation which may occur to a particular patient. A schematic diagram is shown in FIG. 11. The information is comprehensively analyzed by the medical system (such as the responsive system 30), wherein the information of the patient may be represented by one or more specific diagnostic parameters which can be represented by the codes mentioned above. For example, when a patient having kidney disorder, the code of “00053” is assigned to him/her as the specific diagnostic parameter. If the patient is also treated by glucose, a code of “00126” is also assigned with him/her. The resulting parameter would be code “10153” as mentioned above. Treatment and comments would follow this code, as shown in FIG. 12. The corresponding warning would be “be applied with caution”. There are also other warnings, such as “Prescription incompatibility” (FIG. 10) and “Contraindication” (FIG. 9).

The treatment and comments and the record of the diagnostic parameters are to be transmitted to a predetermined information exchange center 60 wherein doctors of different hospital or clinics are able to access the information exchange center 60 for retrieving the corresponding information regarding a particular patient.

The distinctive features of the present invention are further elaborated as follows:

(1) The medical system of the present invention is based on a combination of Chinese medicine, and does not involve direct administering of the Chinese medicine to the patient, such as generation of electrical nerve stimulation (TENS). Doctors reserve the exclusive right and decision-making power of treating the patients.

(2) The use of an effective treatment depends on carefully tested combination of a wide variety of herbs or other medicine. A slight alteration of the combination may have a substantial adverse effect on the medicine performance. The knowledge of different combinations of Chinese medicine is the product of experience and application of ancient Chinese medicine theory. The present invention utilizes official guides and computing technology to identify disease and suggests the optimal treatment methods and/or dosage information. Individual oriental doctors may, however, employ different methods or modify the suggested methods for individual patients. Moreover, it is important to mention that combination of different Chinese medicine may actually have adverse resulting effect to the patient. The database system 20 of the present invention provides cautions for such adverse result. Undesirable combinations can also be avoided following the guidelines of official Chinese medicine information.

(3) Under traditional Chinese medicine theory, a combination of several kinds of Chinese medicine may have a wholly unexpected and novel result for curing a different kind of disease as compared to its individual constituents. The treatment information cannot be obtained solely through analysis of individual ready-prepared Chinese medicines. In short, the information contained in the database system (treatment information) combines official information with extensive experience of doctors in the field. Moreover, doctors have the ultimate decision-making power to determine if a particular treatment method is suitable for a particular patient. Patient history can be retrieved through the information exchange center 60. This prevents inaccurate statements made by patients when interviewing doctors. Sometimes, due to lack of medical knowledge or complete medical history, a doctor seeing a new patient may be misled by information given by the patient. With the information exchange server 60, the doctor is able to retrieve the most accurate medical history of a particular patient, since the information may be input by another doctor in Oriental Chinese medicine.

One skilled in the art will understand that the embodiment of the present invention as shown in the drawings and described above is exemplary only and not intended to be limiting. It will thus be seen that the objects of the present invention have been fully and effectively accomplished. The embodiments have been shown and described for the purposes of illustrating the functional and structural principles of the present invention and is subject to change without departure from such principles. Therefore, this invention includes all modifications encompassed within the spirit and scope of the following claims.

What is claimed is:

1. A medical system, comprising:
a signal input device for entering information to said medical system, wherein an input signal is generated in response to the information entered in said signal input device;
a database system communicating with said signal input device and having a diagnostic database containing Chinese diagnostic information involving Chinese medicine, wherein said database system is capable of analyzing and matching said input signal, wherein said database system is adapted to generate a diagnostic output signal after analyzing and matching said input signal from said signal input device;
a responsive system receiving said diagnostic output signal, wherein said responsive system is arranged to store treatment methods information in Chinese medicine and analyze said diagnostic output signal to formulate a treatment method in Chinese medicine which is optimal with respective to said diagnostic output signal from said treatment methods information in Chinese medicine, wherein said treatment method is delivered through a responsive signal; and
an output device connected with said responsive system for receiving said responsive signal and displaying said corresponding treatment methods information on said output device, wherein said treatment method is arranged to be transmitted to a predetermined information exchange center such that doctors of different hospitals are able to access said treatment methods from said information exchange center for retrieving corresponding information regarding a particular patient.

2. The medical system, as recited in claim 1, wherein said database system further comprises a matching analyzer which is adapted to match and analyze said input signal with said treatment methods information in said database system so as to generate said treatment method in Chinese medicine which is optimal with respective to said diagnostic output signal.

3. The medical system, as recited in claim 1, wherein said responsive system comprises an action database containing said treatment methods information, a signal transmitter adapted for receiving said diagnostic output signal, and a retriever retrieving a corresponding treatment methods information from said action database in responsive to said diagnostic output signal received from said signal transmitter.

4. The medical system, as recited in claim 2, wherein said responsive system comprises an action database containing said treatment methods information, a signal transmitter adapted for receiving said diagnostic output signal, and a retriever retrieving a corresponding treatment methods information from said action database in responsive to said diagnostic output signal received from said signal transmitter.

5. The medical system, as recited in claim 3, wherein said diagnostic database and said action database is linked with each other for effective sharing of data.

6. The medical system, as recited in claim 4, wherein said diagnostic database and said action database is linked with each other for effective sharing of data.

7. The medical system, as recited in claim 1, wherein said medical system further comprises another of said information input device such that information is capable of being entered to said database system simultaneously via said two information input device.

8. The medical system, as recited in claim 5, wherein said medical system further comprises another of said information input device such that information is capable of being entered to said database system simultaneously via said two information input device.

9. The medical system, as recited in claim 6, wherein said medical system further comprises another of said information input device such that information is capable of being entered to said database system simultaneously via said two information input device.

10. The medical system, as recited in claim 1, further comprising a language system communicating with said medical system for transforming said information entered and said corresponding treatment methods information to a predetermined language.

11. The medical system, as recited in claim 4, further comprising a language system communicating with said medical system for transforming said information entered and said corresponding treatment methods information to a predetermined language.

12. The medical system, as recited in claim 6, further comprising a language system communicating with said medical system for transforming said information entered and said corresponding treatment methods information to a predetermined language.

13. The medical system, as recited in claim 9, further comprising a language system communicating with said medical system for transforming said information entered and said corresponding treatment methods information to a predetermined language.

14. The medical system, as recited in claim 1, wherein said signal input device is a word inputting device.

15. The medical system, as recited in claim 13, wherein at least one of said signal input devices is a word inputting device.

16. The medical system, as recited in claim 1, being electrically connected with another of said medical system so as to link said medical systems for allowing exchange of data between said two medical systems for expanding a capability of said treatment methods information.

17. The medical system, as recited in claim 13, being electrically connected with another of said medical system so as to link said medical systems for allowing exchange of data between said two medical systems for expanding a capability of said treatment methods information.

18. The medical system, as recited in claim 15, being electrically connected with another of said medical system so as to link said medical systems for allowing exchange of data between said two medical systems for expanding a capability of said treatment methods information.

19. A method of diagnosis by using a medical system comprising a signal input device, a database system, a responsive system and an output device, wherein said method comprises the steps of:
(a) receiving information by said signal input device, wherein an input signal is generated in response to said information entered in said signal input device;
(b) establishing a diagnostic database in said database system which communicates with said signal input device, wherein said diagnostic database contains Chinese diagnostic information involving Chinese medicine, and is capable of analyzing and matching said input signal, wherein said database system is adapted to generate a diagnostic output signal after analyzing and matching said input signal from said signal input device;
(c) retrieving a predetermined treatment methods from said responsive system in responsive to said information, wherein said responsive system is arranged to store treatment methods information in Chinese medicine and analyze said diagnostic output signal to formulate a treatment method in Chinese medicine which is optimal with respective to said diagnostic output signal from said treatment methods information in Chinese medicine, wherein said treatment method is delivered through a responsive signal; and
(d) presenting said treatment method through said output device connected with said responsive system.

20. The method, as recited in claim 19, wherein said step (b) comprises the steps of:
(b.1) analyzing said predetermined treatment methods; and
(b.2) generating a finalized treatment method from a plurality of treatment methods stored in said database system, wherein said finalized treatment method is optimal in treating a user's condition.
